(19) United States
(12) Patent Application Publication
(10) Pub. No.: US 2022/0368278 A1
(43) Pub. Date: Nov. 17, 2022

(54) Integrated Photovoltaic Module Mounting System with Matingly Connectable Flanged Brackets

(71) Applicant: Watershed Solar, LLC, Norcross, GA (US)

(72) Inventors: Carl M. Davis, III, Canton, GA (US); Kyle Ehman, Milton, GA (US)

(73) Assignee: Watershed Solar, LLC, Norcross, GA (US)

(21) Appl. No.: 17/761,184

(22) PCT Filed: Sep. 17, 2020
(86) PCT No.: PCT/US2020/051281

§ 371 Date: Mar. 16, 2022

Related U.S. Application Data
(60) Provisional application No. 62/901,465, filed on Sep. 17, 2019.

(51) Int. Cl. H02S 30/10; H02S 20/20

(52) U.S. Cl. CPC H02S 30/10; H02S 20/20

(57) ABSTRACT

A photovoltaic module with bottom mounting brackets attached to a first side and each having an extending flange with a top surface of a first character and top mounting brackets attached to a second side and each having an extending flange that defines a bottom surface of a second character, the flanges of the top mounting brackets extending over and engaging the flanges of the bottom mounting brackets of another of the photovoltaic modules, whereby the interconnected modules resist sliding separation during installation. A method of holding adjacent photovoltaic modules during installation on sloped surfaces is disclosed.

### TECHNICAL FIELD

This invention relates to an integrated mounting system for photovoltaic modules for use in solar energy collection. More particularly, the present invention relates to an improved bracket for an integrated mounting system for connecting adjacent photovoltaic modules or solar panels for use in solar energy collection.

### BACKGROUND OF THE INVENTION

Photovoltaic solar modules or solar cells have historically been mounted by use of structured racks that seat on a variety of surfaces such as rooftops, greenfields and brownfields. Recently, mounting systems that use rails have been developed. Typical rail systems include a set of parallel rails to which the photovoltaic modules must be placed upon and then mechanically fastened to secure their position. As shown in the prior art illustrated in FIG. 5, the typical photovoltaic module includes edge mounting brackets that are adhered to the edge of the photovoltaic module panel. One side of the photovoltaic module has a first set of edge mounting brackets 1 with an outwardly extending top flange 2 that is configured to rest upon an outwardly extending bottom flange 3 of a second set of edge mounting brackets 4 mounted to the opposite side of an adjacent photovoltaic module. With the top and bottom flanges 2 and 3 of the adjacent photovoltaic modules overlaying each other, a mounting screw extends through a slot in each flange and into the underlying rail to secure the photovoltaic modules in place upon the rails.

These photovoltaic modules also include electrical connectors that extend from one side edge of each photovoltaic module. As such, the electrical connectors are positioned relative to the flanges regardless of the mounting orientation or position of the photovoltaic module. To maximize the density of photovoltaic modules, when mounting an array of photovoltaic modules, columns of photovoltaic modules are oriented with the electrical connectors extending on one side, while the adjacent row of photovoltaic modules are oriented with the electrical connector on the opposite side. This orientation allows the end edges of the photovoltaic modules of adjacent columns to be placed closely adjacent each other to maximize density, as shown in accordance with the present invention in FIG. 4. However, this means that the photovoltaic modules of one column are rotated so that they are oriented 180 degrees from the photovoltaic modules of the adjacent column.

A problem with the prior art photovoltaic module mounting system is related to the fact that solar energy generation sites typically require large tracts of land. In some locations, the terrain may include hills, valleys or other inclined surfaces. These inclined surfaces typically require the parallel rails to be positioned so that they extend longitudinally in the direction of the incline, i.e., they are oriented so that they extend up and down along the incline rather than across the incline.

As the photovoltaic modules are mounted one by one upon the inclined rails the mounting process typically commences at the bottom or lowest part of one column of rails and continues up the hill. With the brackets of the prior art, as each successive photovoltaic module is mounted upon the inclined rail, gravity will cause the photovoltaic module to slide downwardly against the previously mounted photovoltaic module. This downward sliding may actually beneficially push the top flange of one mounting bracket against the bottom flange of another mounting bracket of the adjacent photovoltaic module when the photovoltaic module are oriented in this direction.

However, once the installer has completed the uphill column, the installer then moves to the next column wherein the installer is mounting the photovoltaic modules in a downhill direction or opposite direction, and the gravitational downward sliding now forces the top flange of one mounting bracket away from the bottom flange of the other mounting bracket of the adjacent photovoltaic module. Because of the constant gravitational separation when mounting photovoltaic modules in the downhill direction, the task of securing the mounting screws through the two mounting brackets requires two people, one to secure the screw while the other holds the photovoltaic module in place.

Accordingly, there is a need in the art for an improved integrated mounting system for securing photovoltaic modules to a surface for generating solar power. It is to such that the present invention is directed.

### SUMMARY OF THE INVENTION

The present invention meets the need in the art by providing an integrated photovoltaic module for mounting to supports, comprising a photovoltaic module having a first side edge and an opposing second side edge. A pair of first mounting brackets attach in spaced relation to the first side edge of the photovoltaic module and each of the first mounting brackets having a laterally extending flange that defines a surface of a first character. A pair of second mounting brackets attach in spaced relation to the second side edge of the photovoltaic module and each of the second mounting brackets having a laterally extending flange that defines a surface of a second character. The first character and second character provide for mating engagement, whereby adjacent photovoltaic modules interconnect by the second mounting brackets of one photovoltaic module overlappingly engaging the first mounting brackets of an adjacent photovoltaic module.

In another aspect, the present invention provides a method of holding adjacent photovoltaic modules during installation on sloped surfaces, comprising the steps of:

(a) providing a pair of photovoltaic modules for installation in adjacent connected relation on a slope surface, each photovoltaic module having:
a first side edge and an opposing second side edge and opposing end edges;
a pair of first mounting brackets attached in spaced relation to the first side edge and each first mounting bracket having a laterally extending flange that defines a surface of a first character; and
a pair of second mounting brackets attached in spaced relation to the second side edge of and each second mounting bracket having a laterally extending flange that defines a surface of a second character for mating overlapping engagement with the flange of a respective one of the first mounting brackets of another of the photovoltaic modules;

(b) installing a first of the pair of photovoltaic modules to a sloped surface with the pair of the second mounting brackets on an upward portion of the sloped surface; and

(c) installing a second of the pair of photovoltaic modules to a sloped surface adjacent the first of the pair of photovoltaic modules with the pair of the second mounting brackets of the second photovoltaic module overlapping and engaging the first mounting brackets of the first photovoltaic module,

whereby the adjacent pair of photovoltaic modules interconnect for resisting sliding apart during installation by the second mounting brackets of the first photovoltaic module engaging the first mounting brackets of the adjacent second photovoltaic module.

In yet another aspect, the present invention provides an integrated photovoltaic module for mounting to supports, comprising a photovoltaic module having a first side edge and an opposing second side edge. A pair of bottom mounting brackets attach in spaced relation to the first side edge of the photovoltaic module and each bottom mounting bracket has a laterally extending flange that defines a top surface of a first character. A pair of top mounting brackets attach in spaced relation to the second side edge of the photovoltaic module and each top mounting bracket has a laterally extending flange that defines a bottom surface of a second character. The flanges of the top mounting brackets provide for mating overlapping engagement with the flanges of the bottom mounting brackets of another of the photovoltaic modules. Adjacent photovoltaic modules interconnect by the top mounting brackets of one photovoltaic module overlapping the bottom mounting brackets of the adjacent photovoltaic module.

Objects, advantages, and features of the present invention will become readily apparent upon a reading of the following detailed description in view of the drawings.

### BRIEF DESCRIPTION OF THE DRAWINGS

FIG. 1 shows an exploded perspective view of the integrated photovoltaic module mounting system in a preferred form of the invention.

FIG. 2 shows an exploded side view of the integrated photovoltaic module mounting system of FIG. 1.

FIG. 3 shows an assembled side view of the integrated photovoltaic module mounting system of FIG. 1.

FIG. 4 shows an exploded top view of the integrated photovoltaic module mounting system of FIG. 1, shown mounted to rails.

FIG. 5 illustrates an exploded side view of a prior art integrated photovoltaic module mounting system.

### DETAILED DESCRIPTION

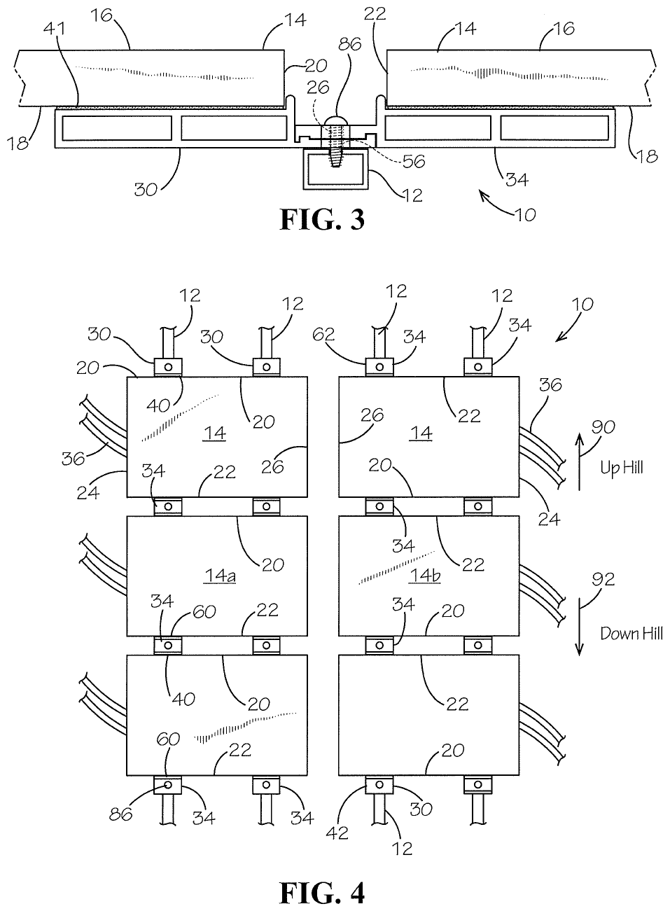

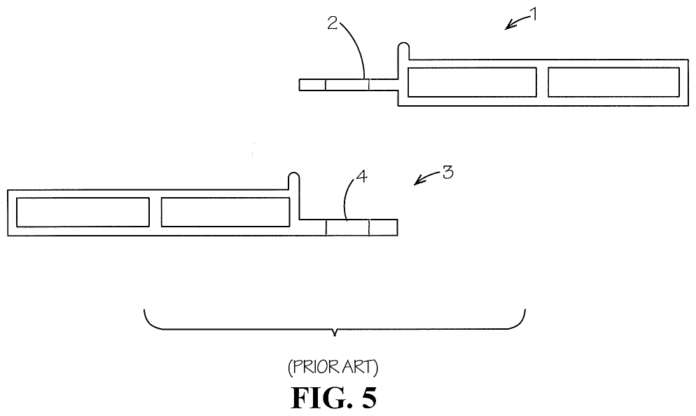

With reference first to FIG. 3 in the drawings, there is shown an integrated photovoltaic module mounting system 10 for use on a surface, such as but not limited to roofs, land or ground surfaces, sloped surfaces, or covered waste sites, upon which are a pair of spaced apart rails 12 for support of photovoltaic modules or solar panels. The mounting system 10 is used in conjunction with one or more modular multi-crystalline photovoltaic module or solar cell, or solar module 14, such as commercially available polycrystalline silicon solar modules. Examples of effective solar modules are available from BYD (China) under the designation BYD 260P6C-30-DG and from Trina (China) under the designation Solar Duomax TSM-PEG14. The mounting system 10 may be configured for use with other ancillary structures such as conventionally known flexible weld harnesses that may be coupled to synthetic turf or other geosynthetic ground cover or geomembranes, as well as racking structures disposed or secured to a support surface.

Each solar module 14 has a solar module panel 16 having a bottom surface 18, a first side edge 20, a second side edge 22 oppositely disposed from the first side edge 20, a first end edge 24, and a second end edge 26 oppositely disposed from the first end edge 24. The solar module 14 also has a first or bottom mounting bracket 30 adhered to the first side edge 20 and bottom surface 18, and a second or top mounting bracket 34 adhered to the second side edge 22 and bottom surface 18. Each solar module panel 16 also has electrical connectors 36 extending, for example, from the first end edge 24. The bottom mounting bracket 30 of one solar module 14 is configured to be coupled or mounted to a top mounting bracket 34 of another, adjacent solar module 14 mounted to the same rails 12. The bottom mounting bracket 30 and top mounting bracket 34 have opposing surfaces that define first characteristics and second characteristics for contacting engagement, mating connection, or coupling together of the bottom mounting bracket 30 of one solar panel with the top mounting bracket 34 of an adjacent solar panel.

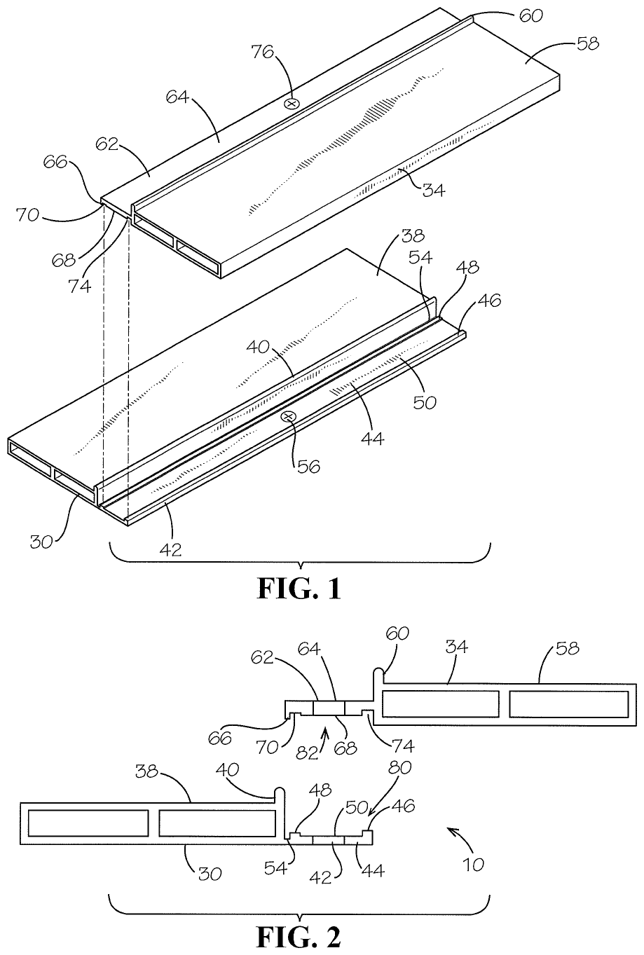

As illustrated in exploded perspective view in FIG. 1 and in exploded side view in FIG. 2, the bottom mounting bracket 30 has a generally planar mounting plate 38 with an upwardly extending mounting edge or ridge 40 configured to abut the solar module panel first side edge 20. The bottom and top mounting brackets 30, 34 attach to respective side edges 20, 22 such as with an adhesive 41 connecting the photovoltaic module 16 to the mounting plate 38 and a portion of the ridge 40.

The bottom mounting bracket 30 also has a mounting flange 42 extending laterally from the mounting plate 38. The mounting flange 42 extends from a portion of the mounting edge 40. The mounting flange 42 defines the first characteristics for interconnecting adjacent solar panels 14 as discussed below. The illustrative embodiment of the bottom mounting bracket 30 includes a base portion or base 44, a first or end ridge or tongue 46 extending upwardly from the base 44, a second or mid-ridge or mid-tongue 48 extending upwardly from the base 44, a first or outboard groove 50 positioned between and defined by the end tongue 46 and mid-tongue 48, and a second or inboard groove 54 positioned between and defined by the mid-tongue 48 and the mounting ridge 40. The mounting flange 42 also includes an elongate mounting hole or slot 56 extending therethrough.

The top mounting bracket 34 has a generally planar mounting plate 58 with an upwardly extending mounting edge or ridge 60 configured to abut the solar module panel second side edge 22. The top mounting bracket 34 also has a mounting flange 62 extending laterally from the mounting plate 58. The mounting flange 62 extends laterally from the mounting edge 60. The mounting flange 62 defines the second characteristics for interconnecting adjacent solar panels 14 as discussed below. The illustrative embodiment of the mounting flange 62 includes a base portion or base 64, a first or end ridge or tongue 66 extending downwardly from the base 64, a second or mid-ridge or mid-tongue 68 extending downwardly from the base 64, a first or outboard groove 70 positioned between and defined by the end tongue 66 and mid-tongue 68, and a second or inboard groove 74 positioned between and defined by the mid-tongue 68 and mounting ridge 60. The mounting flange 62 also includes an elongated mounting hole or slot 76 extending therethrough, the mounting slot 76 being positioned to align with the mounting slot 56 of the bottom mounting bracket 30.

As shown in FIG. 2, the first characteristics of the bottom bracket mounting flange 42 meshes with, matingly connects or engages, or registers with second characteristics of the top mounting flange 62 for engaging adjacent solar panels 14. Particularly in the illustrative embodiment, the top surface 80 of the bottom bracket's mounting flange 42, defined by the top surfaces of the inboard groove 54, mid-tongue 48, outboard groove 50, and end tongue 46, is configured to mesh with, matingly connect to, or be in register with the bottom surface 82 of the top brackets mounting flange 62, defined by the bottom surfaces of the end tongue 66, outboard groove 70, mid-tongue 68, and inboard groove 74. Specifically, the bottom bracket's inboard groove 54 is configured to receive the end tongue 66 of the top bracket 34. The bottom bracket's mid-tongue 48 is configured to be received within the top bracket's outboard groove 70. The bottom bracket's outboard groove 50 is configured to receive the top bracket's mid-tongue 68. The bottom bracket's end tongue 46 is configured to be received within the top bracket's inboard groove 74. The mounting flange 62 extends from the mounting edge 60 at a portion vertically spaced between a lower and upper end of the ridge 60 for overlapping contact of the bottom surface 82 with the upper surface 80 of the opposing mounting flange 42, as show in FIGS. 2 and 3.

The mounting system 10 also includes a mounting screw 86 which is configured to extend through the top mounting bracket mounting slot 76, the bottom mounting bracket mounting slot 56, and be threaded into the underlying rail 12 for securing the mounting brackets to the rail 12.

As shown in FIG. 3, the aligned pairs of the bottom mounting bracket 30 and the top mounting bracket 34 attach to the opposing first and second side edges 20, 22 of the solar panel 14.

With reference to FIG. 4, the mounting system 10 supports the photovoltaic modules or solar panels 16 disposed in spaced relation on support surfaces. The rails 12 of the mounting system 10 in use are aligned in parallel, spaced-apart paired relation. Should the rails 12 be positioned upon an inclined surface, the rails 12 are preferably oriented so that they extend up and down the inclined surface as indicated by slope arrows 90, 92, rather than laterally across the inclined surface.

Once the rails 12 are properly positioned and fixed in spaced relation at the location, each solar module 14 is mounted or coupled to the rails 12. Typically, the installer commences the installation process in the uphill direction by mounting a bottommost or lowermost solar module 14 to the bottommost end of the pair of rails 12. This task is accomplished by aligning the bottom mounting bracket 30 and top mounting bracket 34 upon the rails 12 so that each of their respective mounting holes 56 and 76 are aligned upon the underlying rail 12. The lower or downhill mounting brackets, preferably the pair of top mounting brackets 34 during an uphill sequential installation of panels, are secured to the rails 12 by driving mounting screws 86 through the mounting slots 76 of the top mounting brackets 34.

The next solar module 14a to be installed is then placed uphill and directly adjacent the previously installed solar module 14. The next solar module's top mounting brackets 34 are positioned so that their mounting flanges 62 overlay and mesh with the mounting flanges 42 of the previously installed solar module's bottom mounting brackets 30, and the respective mounting slots 76 and 56 are mutually aligned upon the underlying rails 12. As such, the top mounting bracket's end tongue 66 is received within the bottom mounting bracket's inboard groove 54; the top mounting bracket's outboard groove 70 receives the bottom mounting bracket's mid-tongue 48; the top mounting bracket's mid-tongue 68 is received within the bottom mounting bracket's outboard groove 50; and the top mounting bracket's inboard groove 74 receives the bottom mounting bracket's end tongue 46. The top surface 80 of the bottom flange 42 of the lower installed solar panel 14 matingly engages the opposing bottom surface 82 of the top flange 62 of the adjancent solar panel 14a being installed. Mounting screws 86 are then passed through the aligned mounting holes 76 and 56 of the brackets 30, 34 of the adjacent panels 14, and driven into the underlying rails 12 to secure the positions of the brackets 30 and 34, and thus the position of the solar module 14. The mounting of solar modules 14 continues in this manner until the topmost or most uphill solar module 14 of the column is mounted.

The installer then moves to the adjacent column or pairs of rails 12 and commences installing the solar modules 14 upon the rails 12 in the downhill direction. The installer aligns the bottom mounting bracket 30 and the top mounting bracket 34 upon the rails 12 so that each of their respective mounting holes 56 and 76 are aligned upon the underlying rail 12. The upper or uphill mounting brackets, preferably the pair of top mounting brackets 34, are secured to the rails 12 by driving mounting screws 86 through the mounting slots 76 of the top mounting brackets 34. This positions the bottom mounting bracket 30 on the rails 12 on a lower side of the sloped surface to which the rails are positioned.

The next solar module 14b to be installed is then placed downhill and directly adjacent the previously installed solar module 14. The next solar module's top mounting brackets 34 are positioned so that their mounting flanges 62 overlay and mesh with the mounting flanges 42 of the previously installed solar module's bottom mounting brackets 30. Their respective mounting slots 76 and 56 are mutually aligned upon the underlying rails 12. As such, the top mounting bracket's end tongue 66 is received within the bottom mounting bracket's inboard groove 54; the top mounting bracket's outboard groove 70 receives the bottom mounting bracket's mid-tongue 48′ the top mounting bracket's mid-tongue 68 is received within the bottom mounting bracket's outboard groove 50; and the top mounting bracket's inboard groove 74 receives the bottom mounting bracket's end tongue 46. The top surface 80 of the bottom flange 42 of the installed solar panel 14 matingly engages the opposing bottom surface 82 of the top mounting flange 34 of the to-be-installed solar panel 14b. Mounting screws 86 are then passed through the mounting holes 76 and 56 of the brackets of the adjacent panels 14, and driven into the underlying rails 12 to secure the positions of the brackets 34 and 30 and the solar module 14. The mounting of solar modules 14 continues until the bottommost or most downhill solar module 14 of the column is mounted.

When mounting the solar modules 14 in the downward or downhill direction, the meshing, mating engagement, or registration of the tongues 46, 66 within the respective grooves 54 74 of the bottom and top mounting brackets 30, 34 prevents the mounting brackets 30 and 34 of adjacent solar modules 14, 14b from gravitationally sliding away from or disengaging from each other. This is a great benefit over the prior art mounting brackets which did not prevent such gravitational sliding apart, and which therefore required more than one installer to complete the installation process.

It should be understood that while the preferred embodiment herein shows two pairs of matching tongues and grooves associated with each mounting bracket, the number of matching tongues and grooves may be any number. Furthermore, it should be understood than many other non-planar or irregularly shaped contacting surfaces, catches, or detents between the two mounting brackets may be utilized so long as they prevent sliding movement between coupled solar modules along the direction of the underlying rail.

The distinct advantage to the invention described in the embodiment herein is that the solar panels may be positioned or arranged in a manner that provides for a higher density of solar panels per area of land while allowing the solar panels to be installed on a sloping incline surface, such as a sloped land site, a waste site having steep slopes, or a roof structure, in an easy and efficient manner.

Further, the power leads of the photovoltaic modules are connectably accessible on a standard one side of the panel, as shown in the embodiment illustrated in FIG. 4 on a left side. For the adjacent series of photovoltaic modules in the illustrated electrical current generation system, the installation process starts at the uppermost photovoltaic modules on the right side row shown in FIG. 4 so that the power leads are on accessible on the outside (i.e., right side) of the row. That allows the electrical leads to be readily accessible for connection/disconnection after the photovoltaic modules are physically mounted and secured to the rails. The illustrated sequence of installation of the left row from the lowermost to the uppermost, and then the adjacent row installed from the uppermost to the lowermost, further reduces labor costs.

This invention has been described with particular reference to certain illustrative embodiments but not as limitations, and accordingly, variations and modifications can be made without departing from the spirit and scope of the invention.

What is claimed is:

1. An integrated photovoltaic module for mounting to supports, comprising:
a photovoltaic module having a first side edge and an opposing second side edge and opposing end edges;
a pair of bottom mounting brackets attached in spaced relation to the first side edge of the photovoltaic module and each bottom mounting bracket having a laterally extending flange that defines a top surface of a first character;
a pair of top mounting brackets attached in spaced relation to the second side edge of the photovoltaic module and each top mounting bracket having a laterally extending flange that defines a bottom surface of a second character for mating overlapping engagement with the flange of a respective one of the bottom mounting brackets of another of the photovoltaic modules,
whereby adjacent photovoltaic modules interconnect by the top mounting brackets of one photovoltaic module overlap the bottom mounting brackets of the adjacent photovoltaic module.

2. The integrated photovoltaic module as recited in claim 1, wherein
the first character is defined by a groove in an upper surface of the flange of the bottom mounting bracket; and
the second character is defined by a ridge projecting from a bottom surface of the flange of the top mounting bracket and aligned with the groove in the flange of the bottom mounting bracket of a respective another photovoltaic module,
whereby the overlapping flange of the top mounting bracket having a ridge being received in the groove of the flange of the bottom mounting bracket, engages the top and bottom mounting brackets of adjacent photovoltaic modules in adjacent holding relation.

3. The integrated photovoltaic module as recited in claim 2, wherein the mounting brackets each define a mounting plate and a ridge upstanding therefrom, whereby a surface of the photovoltaic module seats on the mounting plate with a respective first side edge abutting the upstanding ridge.

4. The integrated photovoltaic module as recited in claim 3, further comprising an adhesive for securing the photovoltaic module to the mounting plates.

5. The integrated photovoltaic module as recited in claim 2, wherein the first character is further defined by a ridge upstanding from the upper surface of the flange of the bottom mounting bracket and spaced from the groove therein; and
the second character is further defined by a groove in the bottom surface of the flange of the top mounting bracket spaced from the ridge therein and disposed for alignment with the ridge of the opposing bottom mounting bracket of said respective another photovoltaic module,
whereby the groove of the top mounting bracket receives the ridge of the bottom mounting bracket when the flange of the top mounting bracket of the photovoltaic module overlappingly contacts the bottom mounting bracket of the adjacent photovoltaic module for holding the photovoltaic modules adjacent non-sliding relation.

6. The integrated photovoltaic module as recited in claim 1, wherein the mounting flange of the respective top mounting bracket and the bottom mounting bracket each define a mounting hole for receiving therethrough a fastener for securing the photovoltaic module to a support.

7. The integrated photovoltaic module as recited in claim 1, wherein the flange of the top mounting bracket is vertically spaced to extend laterally for overlapping an upper surface of the flange of the bottom mounting bracket.

8. A method of holding adjacent photovoltaic modules during installation on sloped surfaces comprising the steps of:
(a) providing a pair of photovoltaic modules for installation in adjacent connected relation on a slope surface, each photovoltaic module having:
a first side edge and an opposing second side edge and opposing end edges;
a pair of first mounting brackets attached in spaced relation to the first side edge of the photovoltaic module and each having a laterally extending flange that defines a surface of a first character; and
a pair of second mounting brackets attached in spaced relation to the second side edge of the photovoltaic module and each having a laterally extending flange that defines a surface of a second character for mating overlapping engagement with the flange of a respective one of the first mounting brackets of another of the photovoltaic modules;
(b) installing a first of the pair of photovoltaic modules to a sloped surface with the pair of the second mounting brackets on an upward portion of the sloped surface; and
(c) installing a second of the pair of photovoltaic modules to a sloped surface adjacent the first of the pair of photovoltaic modules with the pair of the second mounting brackets of the second photovoltaic module overlapping and engaging the first mounting brackets of the first photovoltaic module,
whereby the adjacent pair of photovoltaic modules interconnect for resisting sliding apart of the adjacent pair of photovoltaic modules during installation by the second mounting brackets of the first photovoltaic module engaging the first mounting brackets of the adjacent second photovoltaic module.

9. The method as recited in claim 8, wherein the engaging of the bottom surface of the second mounting bracket with the top surface of the first mounting bracket comprises the step of inserting an ridge extending from either the flange of the first mounting bracket or the second mounting bracket into an aligned groove in either the flange of the second mounting bracket or the first mounting bracket, respectively.

10. The method as recited in claim 8, wherein the engaging of the bottom surface of the second mounting bracket with the top surface of the first mounting bracket comprises the step of receiving of a respective ridge within an aligned groove, said ridge and groove in respective opposing flanges of the mounting brackets.

11. An integrated photovoltaic module for mounting to supports, comprising:
a photovoltaic module having a first side edge and an opposing second side edge;
a pair of first mounting brackets attached in spaced relation to the first side edge of the photovoltaic module and each of the first mounting brackets having a laterally extending flange that defines a surface of a first character;
a pair of second mounting brackets attached in spaced relation to the second side edge of the photovoltaic module and each of the second mounting brackets having a laterally extending flange that defines a surface of a second character, the first character and second character for mating engagement,
whereby adjacent photovoltaic modules interconnect by the second mounting brackets of one photovoltaic module overlappingly engaging the first mounting brackets of an adjacent photovoltaic module.

12. The integrated photovoltaic module as recited in claim 11, wherein
the first character is defined by a groove; and
the second character is defined by a projecting ridge disposed for alignment with the groove,
whereby the adjacent photovoltaic modules being engaged by the ridge received in the groove holds the adjacent photovoltaic modules from slipping apart during installation.

13. The integrated photovoltaic module as recited in claim 12, wherein the mounting brackets each define a mounting plate and a ridge upstanding therefrom, whereby a surface of the photovoltaic module seats on the mounting plate with a respective first side edge abutting the upstanding ridge.

14. The integrated photovoltaic module as recited in claim 13, further comprising an adhesive for securing the photovoltaic module to the mounting plates.

15. The integrated photovoltaic module as recited in claim 12, wherein the first character is further defined by a ridge upstanding from the flange of the first mounting bracket and spaced from the groove therein; and
the second character is further defined by a groove in the flange of the second mounting bracket spaced from the ridge therein and disposed for alignment with the ridge of the opposing first mounting bracket,
whereby the groove of the second mounting bracket receives the ridge of the first mounting bracket when the flange of the second mounting bracket overlappingly contacts the first mounting bracket of the adjacent photovoltaic modules for holding in adjacent non-sliding relation.

16. The integrated photovoltaic module as recited in claim 11, wherein the mounting flange of the respective first and second mounting brackets each define a mounting hole for receiving therethrough a fastener for securing the photovoltaic modules to a support.

17. The integrated photovoltaic module as recited in claim 11, wherein the flange of the second mounting bracket is vertically spaced relative to the flange of the first mounting bracket for overlapping contacting engagement.

18. A method of holding adjacent photovoltaic modules during installation on sloped surfaces, comprising the steps of:
(a) providing a pair of photovoltaic modules for installation in adjacent connected relation on a slope surface, each photovoltaic module having:
a first side edge and an opposing second side edge and opposing end edges;
a pair of first mounting brackets attached in spaced relation to the first side edge and each first mounting bracket having a laterally extending flange that defines a surface of a first character; and
a pair of second mounting brackets attached in spaced relation to the second side edge of and each second mounting bracket having a laterally extending flange that defines a surface of a second character for mating overlapping engagement with the flange of a respective one of the first mounting brackets of another of the photovoltaic modules;
(b) installing a first of the pair of photovoltaic modules to a sloped surface with the pair of the second mounting brackets on an upward portion of the sloped surface; and
(c) installing a second of the pair of photovoltaic modules to a sloped surface adjacent the first of the pair of photovoltaic modules with the pair of the second mounting brackets of the second photovoltaic module overlapping and engaging the first mounting brackets of the first photovoltaic module,
whereby the adjacent pair of photovoltaic modules interconnect for resisting sliding apart during installation by the second mounting brackets of the first photovoltaic module engaging the first mounting brackets of the adjacent second photovoltaic module.

19. The method as recited in claim 18, further comprising the step of inserting a ridge projecting from the surface of the flange of the second mounting bracket into a groove defined in the surface of the flange of the first mounting bracket,
whereby the adjacent photovoltaic modules being interconnected resist sliding apart during installation.
